(19) United States
(12) Patent Application Publication
(10) Pub. No.: US 2002/0156700 A1
(43) Pub. Date: Oct. 24, 2002

(54) System of revenue sharing in a computer network environment

(76) Inventors: Joseph Gray, Temecula, CA (US); Brent Peterson, Nuevo, CA (US)

Correspondence Address: CISLO & THOMAS, LLP, 233 WILSHIRE BLVD, SUITE 900, SANTA MONICA, CA, 90401-1211, US

(21) Appl. No.: 10/125,955

(22) Filed: Apr. 19, 2002

Related U.S. Application Data
(60) Provisional application No. 60/285,536, filed on Apr. 20, 2001.

(51) Int. Cl. G06F 17/60

(52) U.S. Cl. 705/26

(57) ABSTRACT

A method of is provided for product companies who generally compete with each other, but do have various products that would otherwise compliment one another, to collaborate together through a global computer network by consolidating their respective product inventories into a shared e-commerce system which allows for product conflict resolution so that each company may send their respective customers into the same online environment through individual web addresses/URLs where the environment then tailors itself to a specific company's brand and products but also offers complimentary products of the other participating companies therefore allowing each company to work together, share customers, and sell complimentary products of one another all through a neutral third party e-commerce revenue sharing technology.

### CROSS-REFERENCE TO RELATED APPLICATIONS

This patent application is related to U.S. Provisional Patent Application Serial No. 60/285,536 filed Apr. 20, 2001 for METHOD OF UPSELLING AND REVENUE SHARING, which application is incorporated herein by this reference thereto.

### BACKGROUND OF THE INVENTION

This invention relates generally to a method of providing product companies who generally compete with each other, but do have various products that would otherwise compliment one another, to collaborate together through a global computer network by consolidating their respective product inventories into a shared e-commerce system. More particularly, the present invention relates to a method and system wherein each company may send their respective customers into the same online environment through individual web addresses/URLs where the network environment tailors itself to a specific company's brand and products and can also offer complimentary products of the other participating companies. This allows each company to work together, share customers, and sell complimentary products of one another all through a neutral third party e-commerce revenue sharing technology.

Direct Response Advertisers (“DRAs”), who advertise their products through television or other media are concerned about doing business on the Internet because of the basic incompatibility of online shopping cart technology to support DRAs' multi-faceted sales approaches. Therefore, what is needed is a way to support multi-faceted sales similar to the conventional method by which Direct Response Television Campaigns are transacted using an 800-number live operator call processing environment.

Basically, under this conventional model, a product is advertised over the television and customers are encouraged to call the number shown in the advertisement. A customer calls the number, is thereby patched through to a call center, where their name, address, and credit card information is captured over the phone to consummate the sale of the advertised product, known as the “base” product. In some cases there are more than one base product that a consumer can choose from as in the case of a music offer that is available in either a Compact Disc format or on Audio Tape. In yet other cases, one or more pre-sell options may be offered. For example, in the case of advertising a base product for five payments of $19.95, a pre-sell option may be used to provide an incentive to consumers who are willing to make one easy payment of $99.75 instead of five payments of $19.95. After the caller's information is captured, including credit card information, and the correct base product is chosen and/or pre-sell is made, if applicable, the operator then offers additional items that can be added to the base purchase. These additional items are commonly known as “upsell” products.

These upsell products typically relate to the advertised product, such as additional units at a discount, a related product, a warranty, etc., and they usually have a proven track record of being of interest to customers of the base product. The telephone operator transacts the multi-faceted sale by telling the customer about each upsell product, including the benefits of the product, the price, and the savings available with an immediate purchase. As the operator offers each upsell, the customer chooses whether or not to accept the offer. After the operator has presented all available upsells the call is then typically concluded without the operator providing a sales total. The customer is simply provided with shipping information such as, “Your order will arrive in 2-3 weeks” and thanked for their order.

Direct Response Advertisers (“DRAs”) are by nature forced to use a multi-faceted sales approach in order to increase revenues to a level where they can profit. For example, when advertising a product for a low price, such as for instance $19.95, it is imperative that upsell products are offered and converted at the point of purchase otherwise the advertiser would likely not generate enough income to pay for the costs of the advertising time. Because of this economic reality, DRAs usually offer upsells as part of their multi-faceted sales approach. In order to keep upsell percentages as high as possible, and to avoid order abandonment, DRAs generally do not provide sub-totals during the telephone sales process nor a grand total at the end of the sale for fear that the aggregate amount might trigger an adverse reaction.

The most widely used method of making Internet transactions today is the online shopping cart method. Using the online shopping cart method, a customer may select a product or service that he or she desires by pointing at the item on a computer screen and clicking a computer mouse button. This causes the item to be placed on a list or “in a shopping cart” that keeps a tally of all currently selected items for view by the customer. Additional individual items can be selected and added to this shopping cart at anytime, and selected items can also be easily removed from the shopping cart.

As the customer adds items to the shopping cart, the total price of the accumulated sale grows. One result of using this common shopping cart approach is that, as a customer accumulates different items in his or her shopping cart, the shear cost of the accumulating bill may encourage the customer to abandon the entire shopping cart altogether, commonly referred to as “shopping cart abandonment.”

As discussed above, DRAs have developed valuable and proven methods to generate sales using a multi-faceted sales approach which generally does not include providing consumers with sub-totals during the purchase or a grand-total at the end of the purchase. Moreover, DRAs have developed proven methods of offering and selling upsell products to consumers at the time of purchase. Under a typical shopping cart method, DRAs are not able to offer upsell products separate from the base products since all products placed into the shopping cart basket are treated as a single larger sale causing unacceptable order abandonment. Further, since DRAs use multiple upsells for every base product it becomes very difficult to present all relevant upsells to consumers as they place multiple base products in their shopping cart. For example, a consumer may place four base products into their shopping cart each of which may have four upsells. This would require the consumer to be presented with a total of 16 upsells at checkout, which shopping carts were not designed to support. Even if such upsells could be supported, the resulting grand-total upon checkout would lead to the undesirable result of the customer ultimately developing “sticker shock” and abandoning the shopping cart entirely.

In the absence of an alternative to the online shopping cart model to support multi-faceted sales over the Internet, DRAs that rely upon upsells as part of their business model have typically chosen either to forego this potential upsell revenue over the Internet or to forego Internet transactions entirely. That is, once a DRA has expended substantial sums attracting a customer to purchase the base product, the DRA is unwilling to send the consumer to a website where they are unable to offer their upsell products and/or risk order abandonment by doing so. Thus, for any such sale transacted over the Internet, the DRA would be forced to forego these upsells, given the limitations of online shopping-cart technology, and as a result may enjoy substantially less revenue per customer over the Internet than through the conventional call center method.

Thus, DRAs have not been able to take full advantage of their multi-faceted sales approach through the Internet without concomitantly risking losing the very customer transaction that they have spent so much effort to attract.

The incompatibility of shopping carts with the multi-faceted sales approach has also made it impossible for DRAs to use web addresses in television commercials when working with television Stations on a revenue sharing basis. Acquiring media from stations on a shared risk or revenue sharing basis is a multi-million dollar business in the direct response television industry. When offering stations a commission per sale, resulting from consumers calling unique 800 numbers being aired by unique stations, the DRA will typically account for upsell sales by increasing the commission per “base sale” offered to stations. For example, on a Ab Exercise product, the base product may sell for $29.95 but because of upsells the average sale might be $49.95. Accordingly, where a DRA might share only 50% of the $29.95 base sale as revenue with a television station ($14.97), they would now be able to pay the station $24.95 per base sale. Given the expense of television time, revenue sharing with television stations is very competitive, and the upsell revenue becomes critical in making advertising campaigns economically viable. Because of the standard shopping cart approach that does not support or convert product upsells, DRAs can not afford to pay the same commission to television stations when people order the advertised product over the Internet. Since there is a negative economic benefit caused by sending consumers to the web to order, through a shopping cart, neither the DRA nor the television station can justify supporting web ordering as part of their revenue sharing arrangement, and therefore typically include only an 800 number to order.

Therefore, what is also needed in the art is a method for use over the world wide web of generating upsells while nevertheless eliminating online shopping cart abandonment so that DRAs can enjoy and share with one another the increased revenue that results from upsells an when selling their products over the Internet and transacting business in a shared e-commerce revenue sharing environment. In addition, a method for allowing television stations, working with DRAs on a revenue sharing basis, to also particulate in the same shared e-commerce revenue sharing environment where they can now be compensated for web orders on the same economic basis as 800 phone call orders as well as share in additional commissions earned by consumers buying other complimentary products which is one of the distinct benefits that every member of the online revenue sharing network technology enjoys.

### SUMMARY OF INVENTION

The present invention involves a method of providing product companies that generally compete with each other, but have various products that would otherwise compliment one another, the ability to collaborate through a global computer network by consolidating respective product inventories into a shared e-commerce system. The invention also allows for product conflict resolution so that each company can send their respective customers into the same online environment through individual web addresses/URLs where the environment then tailors itself to a specific company's brand and products. Offers of complimentary products of the other participating companies are possible, allowing each company to work together, share customers, and sell complimentary products of one another all through a neutral third party e-commerce revenue sharing technology.

Thus, one embodiment of the present invention involves the steps of advertising for sale by a target organization of one or more of its target products or services and offering to transact a sale of these products or services through a target Internet website, displaying one or more web pages through this target website which display not only the target organization's products or services but also lateral products or services for sale by participating lateral organizations; and allowing those participating lateral organizations to thereby offer for sale their lateral products or services.

More specifically, one important facet of this invention is the fact that a number of companies in the same industry who are normally in direct competition with one another, can now cooperate with a financial advantage to each other over a global computer network. In accordance with this arrangement, an organization (e.g., a target organization), which offers certain selected products, can also promote to its financial advantage, products of a competitor (lateral organization). By allowing the customer to view web pages of the lateral organization, along with the target organization's own target products, it can arrange for the sale of those lateral products and generate a commission, which would otherwise not have been earned.

In addition to the above, any one organization, such as a target organization, can increase or otherwise modify, its product line to essentially allow for marketing and sale of the products of its competitors. As a simple example, a hardware that offered a limited range of tools can now offer a wide range of tools through the display of web pages of its competitors containing tools not in the inventory of the target organization. Not only does this increase customer satisfaction, it also leads to a good potential for return customers. Moreover, this arrangement provides for a more competitor friendly marketing and selling atmosphere, to an extend which did not heretofore exist.

In addition to the above, revenue sharing allows each of the organizations, including the target organizations and the lateral organizations, to sell their respective products and where both can gain financial reward.

This approach can also be utilized with a method of upselling as described in Applicant's co-pending application filed Apr. 19, 2002 entitled SYSTEM OF UPSELLING IN A COMPUTER NETWORK ENVIRONMENT, serial number not yet assigned, to sell additional goods or services.

It is therefore an object of the present invention to provide a method for gathering together disparate companies over a global computer network, including companies that regularly compete with each other for customers and who might not otherwise cooperate, to provide a single source or a single network of sites to meet more of the customers' needs.

It is also an object of the present invention to provide a single industry-wide website where customers can visit and purchase products from companies that otherwise directly compete with one another.

Another object of the present invention is to provide an overall increased Internet exposure for a company's products.

It is also an object of the present invention to provide for an additional stream of revenue for a company once it has. attracted customers to the website or network of sites.

Still another object of the present invention is to provide an Internet search and marketing model that provides more revenue, power, and leverage to the participating companies than under currently available Internet search and clearinghouse models.

Still another object of the present invention involves providing additional incentives for a Direct Response Advertiser (“DRA”) to offer its products directly to customers over the Internet where up to now DRAs have been reluctant to transact business.

A further object of the present invention is to provide a method of revenue sharing where advertisers can reward each other, and their affiliates, at rates that are similar to the convention telephone-center model where upsells have always been supported.

A still further object of the present invention is to provide a method for promoting product-specific upsells while protecting against abandonment of the base product sale.

These and other objects and advantages of the present invention will be apparent from a review of the following specification and accompanying drawings.

### BRIEF DESCRIPTION OF THE DRAWINGS

FIG. 1 is a diagram illustrating one embodiment of the present invention showing a host website and a number of store front websites for a number of participating organizations.

FIG. 2 is a printout of a store front page of a website of one embodiment of the present invention showing a number of base products.

FIG. 3 is a printout of a subsequent web page displaying a number of products, including some lateral products.

FIG. 4 is a printout of a store front web page of another participating company showing a number of its base products.

FIG. 5 is a printout of a subsequent web page of the company of FIG. 4 showing a number of products, including some of lateral products.

FIG. 6 is a printout of a store front web page of yet another participating company showing a number of its base products.

FIG. 7 is a printout of a subsequent web page of the company of FIG. 6 showing a number of products, including some of lateral products, but not the directly competing product as discussed below.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

One embodiment of the present invention involves the Direct Response Television (“As Seen on TV”) Industry. Because of the invention, Direct Response Advertisers (“DRAs”) who advertise their products through television advertisements are able to collaborate together each driving web traffic from television into a shared e-commerce system. The e-commerce site then tailors itself according to the given URL information to appear as a branded AS SEEN ON TV superstore for a specific DRA containing its own products on the front page and all complimentary products, of other participating DRAs, on subsequent web pages within the site.

Thus, an embodiment of the present invention involves a system and method of revenue sharing wherein several companies can sell their products over the Internet in either a network of websites or in a single website. Each participating company or organization may have a unique “store front” web page wherein a customer of that company would first see that company's advertised products, and secondarily may also view and purchase the products of other participating companies. The customer is carefully tracked so that the participating company or organization that the customer first visits—referred to herein as the “target” company because it is the target of the advertisement that initially interested the customer—will enjoy a commission from any sale of products of other participating companies during that web session or visit by the customer. Under certain circumstances, the customer is likewise tracked during subsequent web sessions, allowing the original target company or organization to again enjoy in similar commissions for sales made during subsequent web sessions.

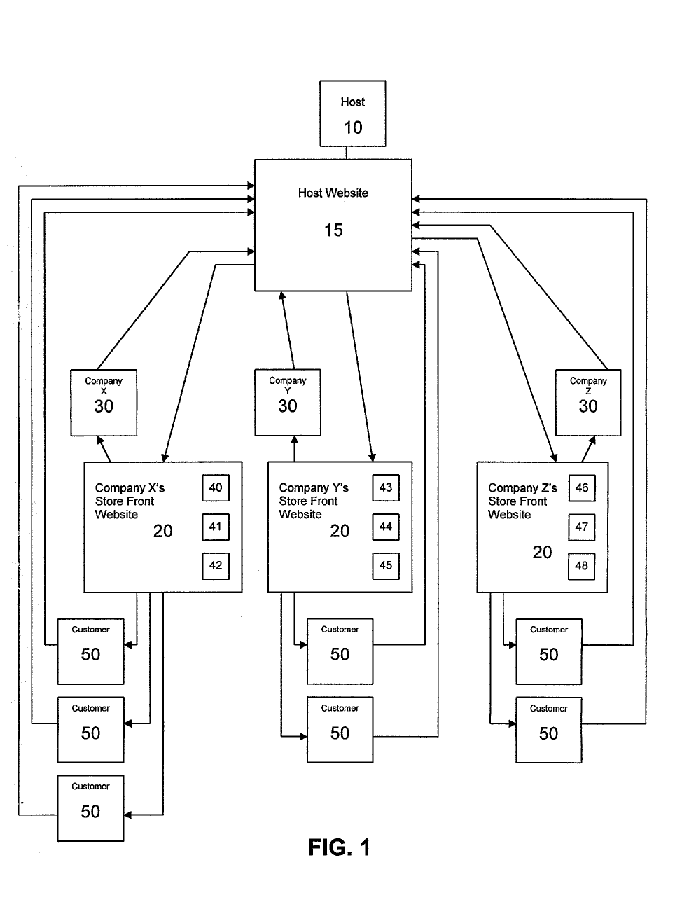

As shown in FIG. 1, one embodiment of the present invention involves a method of revenue sharing wherein a single host company 10 manages several “store front” websites 20 through a single “host” website 15. Each store front website corresponds to a participating company or organization 30 and comprises a display of products or services for sale 40-48, some of which are the corresponding company's products or services, and others of which are products of other participating companies.

Each participating company 30 advertises its store front website 20 as a way its customers can purchase its advertised product or products 40-48. When a customer 50 chooses to purchase the advertised product through the company's website, the customer will type in the website address as shown in the advertisement. For the purposes of this application, the advertising company that attracted the customer will be referred to as the “target” company as distinguished from the other participating companies, and the advertised product will be referred to as the “base” product as distinguished from products customarily related to the base product and often offered for sale in connection with the base product (referred to herein as “upsell” products) as well as the products offered for sale by the other participating companies (referred to herein as “lateral” products).

For the purposes of illustration, applicant refers herein to “a network of websites” or a “host website” managing several “store front websites.” These references should be construed to equally refer to an arrangement where the “store front” websites are simply a URL address that routes the customer to the host website. In this embodiment, the host website acknowledges which URL routed the customer to it, thereby identifies the target company, and then tailors the website presentation and the various scripts according to the wishes of the target company. This latter arrangement is equally referred to herein as a “network of websites” and a “host website” managing several “store front websites.”

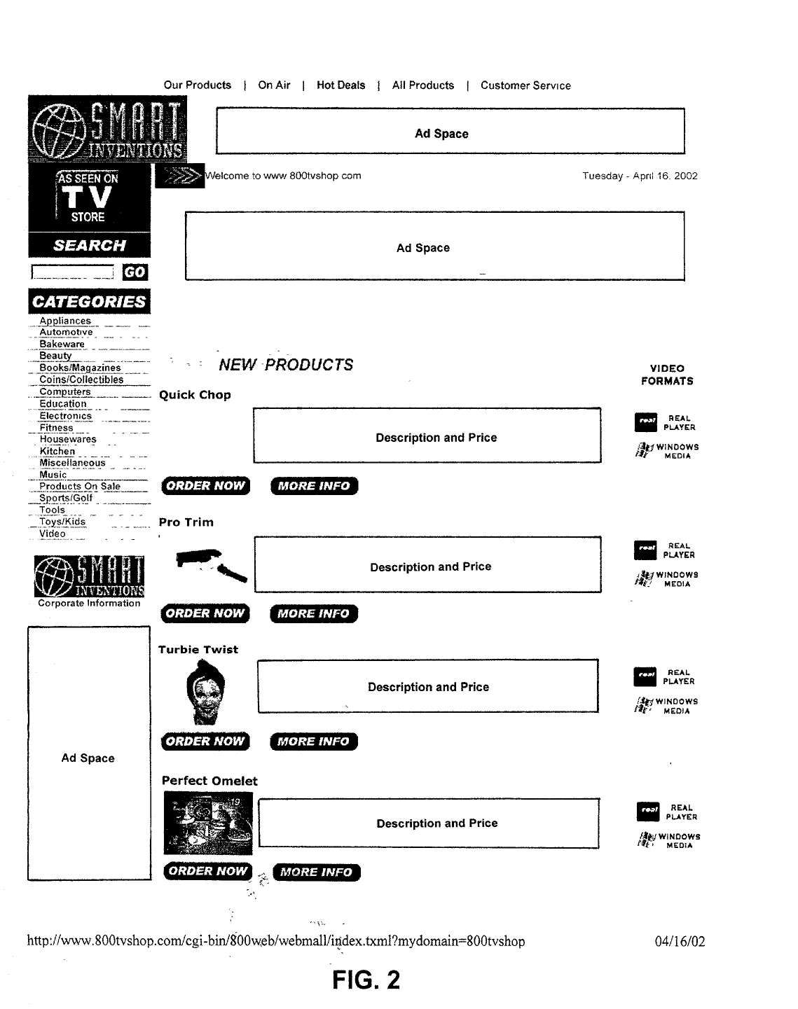

Thus, when the customer types in the advertised website address into his or her computer, the software in the host website 15 keeps track of this initial contact information, such as by assigning a tracking code to the customer or by placing a cookie on the customer's computer, or both. Based on the store front website address the customer typed in, the host site identifies the corresponding target company or organization 30 and displays a customized web page that operates like an online “store front” for the target company as shown in FIG. 2. Many of the various design features of the store front are selected by the target company, such as the company logo, where it is displayed, what color combinations and graphical interface features are displayed, and the like. For all practical purposes, therefore, the store front website becomes a store front presence over the Internet for the target company.

Also, the products offered for sale through this store front and the arrangement of these products are dictated by the target company and will typically correspond with the target company's current advertising campaigns, promotional drives, and/or currently-aired infomercials. That is, the first web page of store front website will typically contain the target company's most popular or most heavily marketed products at any given time, and may be regularly monitored and updated by the target company. Subsequent web pages, however, will ordinarily contain the products of other participating companies, referred to herein as “lateral” products, except that any such lateral product that directly competes with a product of the target company will be removed from these subsequent web pages of the target company's site.

In one embodiment, competitors actually allow their products to be shown in the subsequent web pages of each other's store front website. For example, company X and company Y may be staunch competitors in one or even many product offerings. In this embodiment, they each nevertheless benefit from having a website managed by the host website which would manage a relatively unique store front website for company X and a relatively unique store front website for company Y. Each store front website contains links to other, subsequent web pages that show the competitor's products to the extent that the products do not create a direct conflict, but would not display the competitor's directly competing product.

For instance, as shown in FIG. 2, company X may sell an omelet making product under the “Perfect Omelet” trademark, company Y may sell a directly competing omelet cooker under the “Omelet Wave” trademark. A customer who sees an advertisement for a company X product and thereby visits company X's store front website would find the Perfect Omelet offered for sale, either in the first web page or at least on a subsequent web page, depending on company X's business decision on what products to promote most heavily at a given time. This customer, however, would not find the Omelet Wave product anywhere.

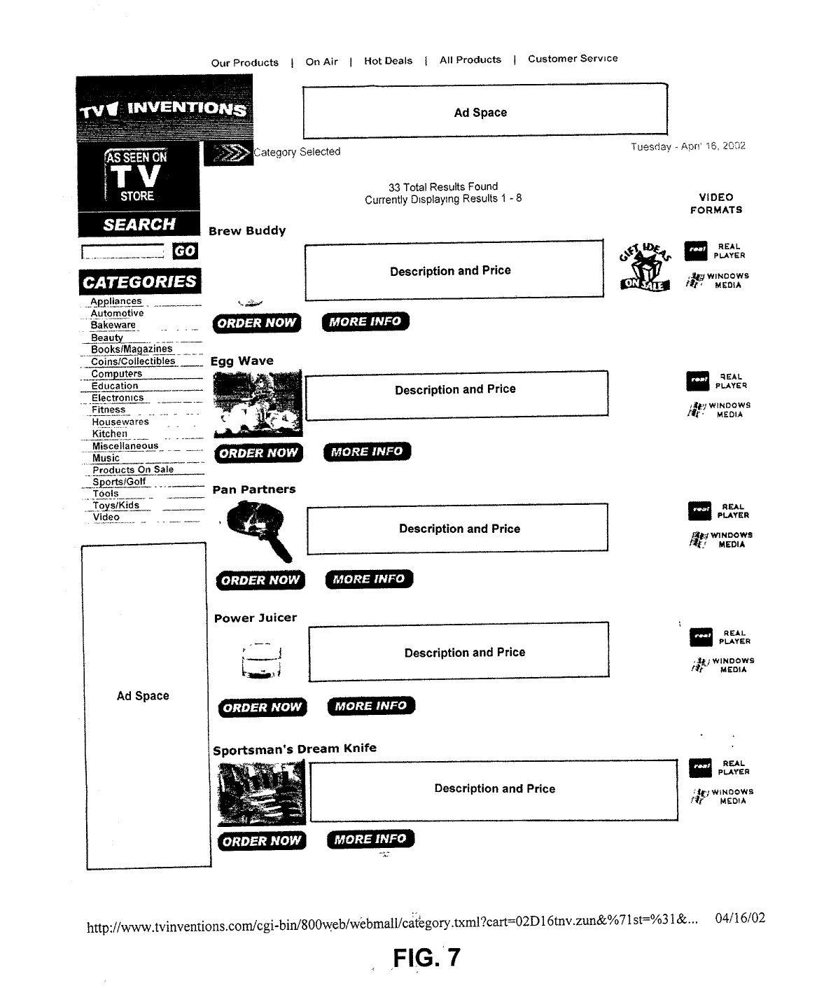

On the other hand, a customer who visits company Y's store front website would find the Omelet Wave product offered for sale, either on company Y's first web page or on a subsequent web page, as shown in FIG. 7, but would not find the Perfect Omelet offered for sale anywhere during his or her visit. While other lateral products from company X will be viewable by this customer and therefore readily available for purchase, the conflicting Perfect Omelet product will not be displayed to this customer.

This will have the tendency of promoting company Y's Omelet Wave product to to customers that were attracted to visiting company Y's store front website, presumably due to seeing the website advertised in a company Y advertisement. In this way, company Y can participate in this website and revenue sharing arrangement and still rest assured that its customers brought in by its advertising will be more likely to purchase its Omelet Wave, and company X can participate in this website and revenue sharing arrangement and still rest assured that its customers brought in by its advertising will be more likely to purchase its Perfect Omelet.

Additionally, when a customer follows a company X advertisement and thereby visits company X's store front website, to give company X its due credit for attracting the customer to this network of websites, a standard noninvasive cookie is placed on the customer's computer identifying the customer as initially a company X customer. As a result, if the customer again visits any of the websites or subsequent web pages anytime within a predetermined period of time, such as six months or a year, company X continues to get credit—and commissions if applicable—for the customer's return and any purchases made, provided that this latter visit does not itself occur through the store front website of another participating company.

This allows competitors, even direct competitors that would likely not otherwise cooperate in any commercial venture, to market their products under a single host website 15 while at the same time never risking any significant loss of customers to direct competitors nor any violation of any anti-competition laws. As a result, the host website 15 could itself be advertised as a site to visit for all of the public's industry-related needs, such as a plumbing site, a house wares site, a services sector site, and the like.

The benefits in this embodiment to company Y, however, greatly outweigh its tendency to trenchantly avoid cooperating with a direct competitor. First, as discussed above, company Y can participate in this network of websites without the fear that its own customers will buy company X's directly competing product through this network of websites. Second, this model of a network of websites managed by a host website allows company Y to provide its customers with a much greater selection of products, including non-conflicting lateral products (i.e., not directly competing with a company Y product) supplied by other participating companies. Third, company Y's own non-conflicting products will be equally offered for sale to the customers of the other participating companies, as well as any upsell products as further described below. Fourth, for every customer of company Y who buys a lateral product (i.e., a product supplied by another participating company), company Y earns a commission. Fifth, as the particular network of websites grows to encompass, for example, a majority of a given industry or a sizable “online mall,” company Y will want to be involved in the network of websites because they will become essentially the primary shopping destination, or company Y may in fact find that it cannot afford not to be in the network.

The price of all of this added exposure is minimal. Each host website manages all of the technical issues of the website network, and provides the above-listed services, in exchange for a nominal fee, such as a fixed dollar amount per item sold or some other transaction fee based on for instance the amount of sales. Also, as described above, company Y would be required to pay a commission to participating company X for any sale of a company Y product to a customer brought into the network through company X's store front website.

This too is seen as very advantageous to company Y even though its revenues are reduced by this commission amount on such sales since the sale would presumably not have occurred at all, but for this participating company's advertising efforts (albeit with respect to some other product). Moreover, this is seen as particularly advantageous since this cross-pollenization, in effect, exposes this new customer to company Y's upsell products as described in more detail below, at virtually no additional expense. That is, while the commission for a sale of a company Y product to a company X customer is set and completed as of the sale of this base product, the customer is then offered one or more upsell products that have been determined likely to be of particular interest to a customer who purchases this base product. Also, the transaction fee charged by the host may also be based solely on the sale of a base product. Any subsequent sale of upsell products, therefore, represents revenue entirely to company Y—from a company X customer that would likely not have otherwise even learn about company Y's products.

Additionally, one embodiment of this method further involves means for tracking the customer even outside of the website environment. For instance, it is well known that a certain percentage of customers will prefer to complete a transaction using a more traditional method, even if they are comfortable to conduct their shopping over the Internet. Thus, each customer may be assigned a tracking code so that, if the customer elects ultimately to purchase a product by telephone or by mail, the telephone operator or mail-in order form will ask for the customer's tracking code. The tracking code will contain sufficient information to determine which company's store front website the customer had visited. In this way, this company will be credited for any purchase by the customer through a telephone operator or through the mail, and the company will enjoy any commissions due it as otherwise described above.

Alternatively, sufficient tracking code information could be derived from the telephone number or mailing address given to the client when the client chooses to purchase a product by telephone or by mail. That is, each participating company may also be assigned a number of telephone numbers and/or post office boxes. When a customer shops over the Internet but elects to purchase a product by telephone or by mail instead of over the Internet, the customer will be given a telephone number and/or mailing address to complete the sale. The telephone number and/or mailing address could then be selected on the basis of the tracking code or other means sufficient to relay sufficient information regarding which store front website brought the customer into the system.

In addition, the system can also track customers by maintaining them within the system, such as initially providing a customer service telephone number managed by the host company or organization, rather than any participating company. As a result, a customer that has a question while visiting the network of websites will reach the host organization, rather than any participating company individually, and the host organization can thereby answer the customer's questions and direct the bask to the system. Once a customer purchases a product, however, the customer service telephone number corresponding to the company supplying the purchased product may be printed on the thank you screen and in the email confirmation.

Also, the host website may place a standard non-invasive cookie or other tagging information on the customer's computer. As a result, even if the customer leaves the store front website and returns many months later, the cookie or other information could be used to identify which store front website initially brought in this customer. As is customary, the cookie would stay on the customer's computer system until it is deleted or corrupted by the customer or some third party, or until it is superseded by a subsequent cookie. That is, it is possible that the customer may in the future be attracted to the network of websites as a result of an advertisement by another participating company. If this occurs, the website address advertised by this other company would be different from the website of the earlier company. As a result, the tracking code for the customer and any cookie placed on the customer's computer would reflect this new website address, and this new participating company would get any applicable commissions derived from any sale if lateral products.

Thus, in one embodiment, a DRA advertises a base product in an advertisement, promotion, or infomercial. The promotion could be a printed advertisement, or it could be broadcast on network television, cable, radio, or the Internet. The promotion indicates that customers may purchase the advertised product in a number of ways, one of which is through an Internet website. An interested customer who chooses to purchase the product over the Internet would then type in an Internet website address into his computer's Internet software.

When the customer types in the advertised website address, the customer encounters the target company's store front web page, such as the one shown in FIG. 2. On this web page, the customer easily finds the advertised base product “as seen on TV” or other advertisement, and he or she is guided through the simple steps necessary to purchase the product, such as entering a billing address and shipping address, etc. If the customer is a repeat customer, this transaction is even further streamlined by the use of previously stored information, such as in the form of a cookie, provided the customer has elected this option. The customer decides to purchase the advertised product, and completes the purchase of the product. Thus, the transaction is consummated with a minimum amount of effort by the customer, and he or she is then charged for the purchase.

Thereafter, the host website offers for sale to the customer one or more items that are related in some way to the base product, referred to herein as “upsell products.” The customer is free to purchase any one or more, or none, of these upsell products. If the customer elects not to buy any upsell products, or if the customer otherwise abandons the offer of upsell products, the upsell transaction is deemed to be not accepted, but the already consummated sale of the base products is not compromised and will still be shipped to the customer, or a certificate of sufficient nature to identify the service, if a service is purchased, such as a warranty protection or other service. In the case of a base sale only, a email receipt may be sent to the customer informing the customer about only the consummated sale of the base products. However, if any upsells were purchased after the base sale transaction, they will also be itemized in the email receipt along with the grand total of the now consolidated sale.

The multi-step sales process of the invention allows DRAs to keep the sale of the base products separate from the upsell products during the online transaction. By doing so, the base product sale is never compromised which is another significant improvement over conventional telephone ordering methods. With telephone ordering methods, if a customer hangs up the telephone at anytime during the upsell transaction, the base sale transaction is usually considered abandoned and rescinded. Additionally, by treating the upsells as a separate sale online, DRAs are able to convert a large and more difficult sale into two smaller sales making the sales process much easier to convert.

In an alternative embodiment of the present invention, each upsell product or service constitutes a separate and distinct transaction that is fully consummated before the customer is offered another upsell product or service. However, in order for the DRAs to process the web orders in the same manner as the telephone orders, the ultimate sale must be consolidated so that the DRAs can bill and ship both the base products and the upsells together as a single purchase which is consistent with their normal business practices. This is an important distinction because otherwise DRAs would have to change their billing and fulfillment practices which would be very expensive and time consuming.

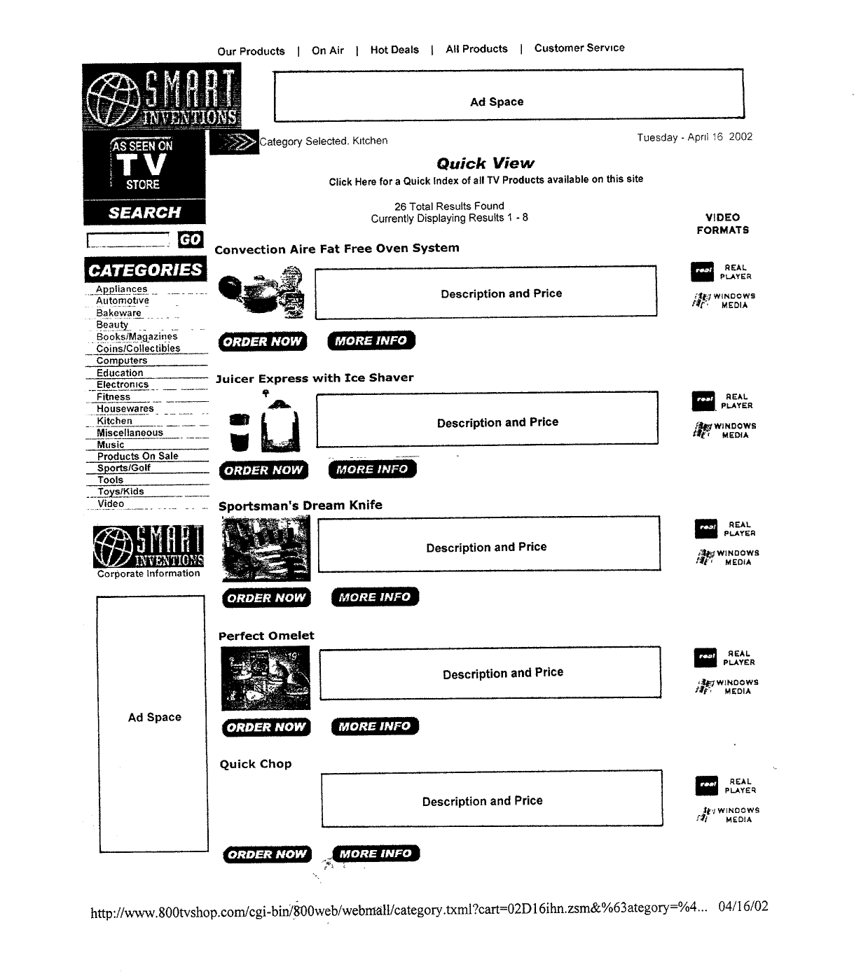

Alternatively, the customer may choose to shop around and purchase other products offered on subsequent web pages. For example, the customer may click on the “Kitchen” hyperlink to view kitchen-related offerings. The store front website, managed by the host website, then displays a list of kitchen-related products available to purchase. The list contains other offerings by the target company, by it also may contain one or more lateral products from other participating companies. An example of such a list is shown in FIG. 3. In FIG. 3, the “Perfect Omelet” and “Quick Chop” are products offered by the target company. One can tell that these two products are the target company's products because they are also displayed on the target company's store front web page, FIG. 2.

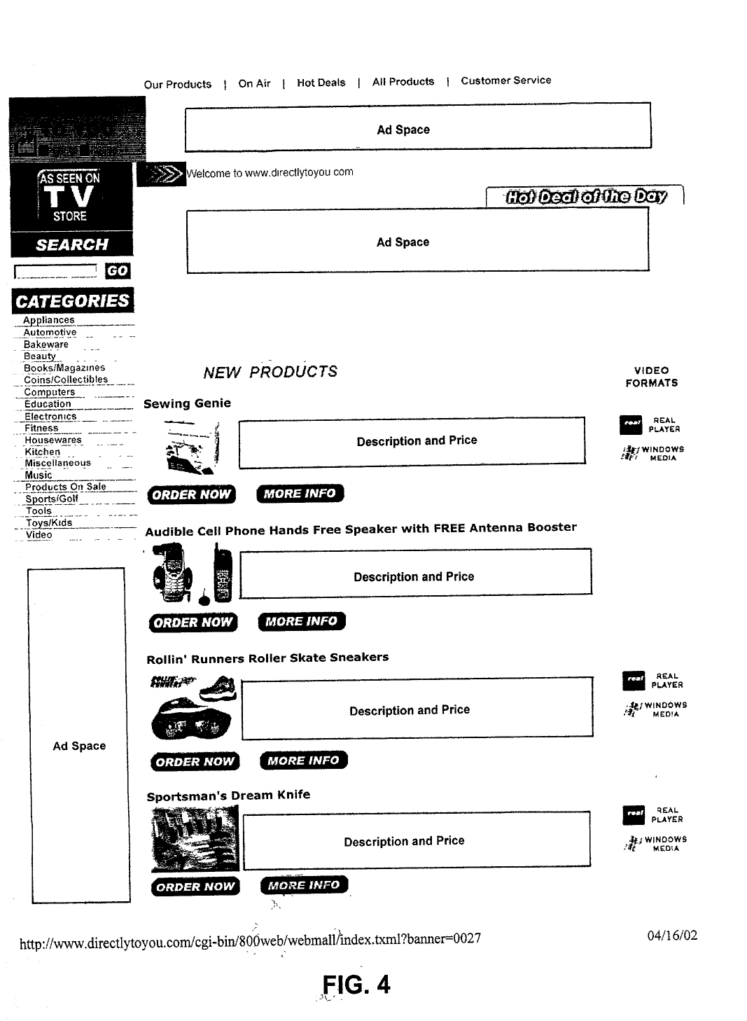

Likewise, the subsequent web pages may well display other kitchen-related products of the target company, including ones that may or may not be selected by the target company to also be displayed on its store front web page. In addition, however, these subsequent web pages may also display several other products, referred to herein as lateral products, of other participating companies. For example, the last product displayed in FIG. 3 is called the “Sportsman's Dream Knife.” This product is a lateral product offered by another participating company. One can tell that this product is a lateral product offered for sale by another participating company because it is displayed on the store front web page of another participating company, as shown in FIG. 4. For the sake of the discussion that follows, this other participating company will be referred to herein as the lateral company or lateral organization.

A customer of the target company, however, would not typically have any reason to concern him or herself with which companies are offering which products, and would not typically enter the network of websites through any website address other than the address of the target company. The additional store front website shown in FIG. 4, therefore, is shown simply to illustrate the interplay of participating companies, their products, and the display of these products within the network of websites all managed by the host website.

If a customer of the target company elects to purchase a “Sportsman's Dream Knife,” he or she may do so simply by clicking on the “Order Now” hyperlink. The script that follows is preset by the host company in connection with the desires of the lateral company. The target company will have no involvement in the script with respect to this lateral product. Once the customer provides the necessary billing and shipping information and thereby verifies the base purchase, the host website displays a thank you window at which time the upsell process begins. At the point of the base sale consummation, the target company receives a commission for the sale, regardless of whether any upsell products or services are purchased, and the host company receives a nominal transaction fee as described above.

The host website continues to deliver a script to the customer offering for sale to the customer one or more upsell items related in some way to the lateral product. The customer is free to purchase any one or more, or none, of these upsell products. If the customer elects not to buy any upsell products, or if the customer otherwise abandons the offer of upsell products, the upsell transaction is deemed to be not accepted, but the already consummated sale of the his lateral base product(s) is not compromised and will still be shipped to the customer. In the case of a lateral base sale only, a email receipt may be sent to the customer informing the customer about only the consummated sale of the base products. However, if any upsells were purchased after the lateral base sale transaction, they will also be itemized in the email receipt along with the grand total of the now consolidated sale.

In one embodiment, the commission the target organization receives for the sale of lateral products is calculated on the basis of the lateral base product, and the target organization is entitled to the commission upon the consummation of the lateral base product sale. Alternatively, the commission may be based on the sale of any such upsell products as well. In another preferred embodiment, the amount of the commission, as a practical matter, is based on a calculation by the lateral company or by the host company based on the revenue from the sale of the lateral base product plus the expected revenue from any upsell products related to the lateral base product, and the target organization is entitled to this commission at the consummation of the sale of the lateral base product. This amount may be derived from standard statistical models based on past sales, or it could be arrived at by other means acceptable to the lateral company and/or the host company. For instance, in the Ab Exercise example provided above, taken from the conventional call center model, the commission was $24.95 even though the base sale itself was $29.95. The commission can be this large due to the anticipated amount of the upsells.

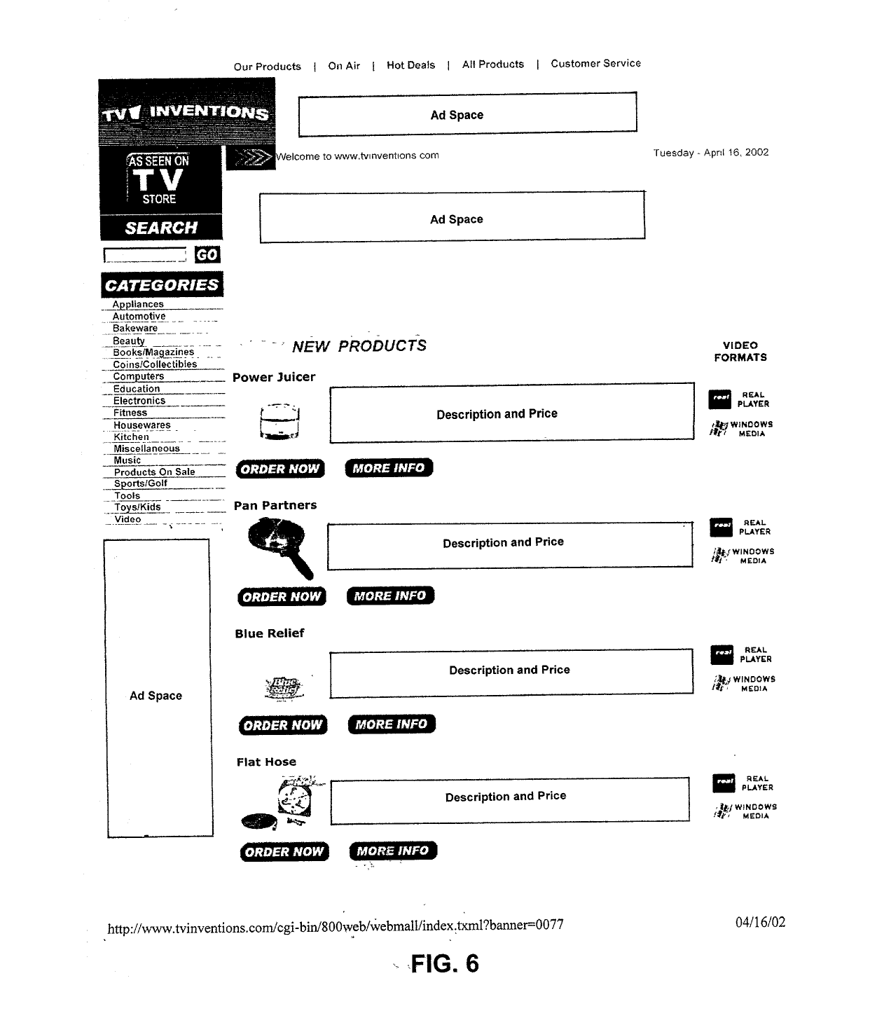

FIG. 6 shows another participating company's store front website. For the purposes of this application, this latter participating company will be referred to herein as a competing company since it has one or more products that directly compete with products of the target company, and vice versa. In particular, as can be seen in FIGS. 2 and 3, the target company advertises a product called the “Perfect Omelet,” whereas the competing company advertises a product called the “Omelet Wave,” as discussed above. While the competing company's store front website, shown in FIG. 6, does not display its “Omelet Wave,” this competing product is displayed instead in the competing company's subsequent web pages when the “Kitchen” hyperlink is selected by the customer, such as is shown in FIG. 7. Nowhere in FIG. 3 is the target company's “Perfect Omelet” product displayed. Likewise, nowhere in FIG. 7 is the competing company's “Omelet Wave” product displayed. In this way, a customer of the target company will be more likely to purchase the target company's “Perfect Omelet” product, and a customer of the competing company will be more likely to purchase the competing company's “Omelet Wave” product. Thus, even competing DRAs can participate since conflict filters can be used so that participating organizations can restrict the products that appear so that other directly competing products do not appear with their own on any particular web page when viewed by their clients.

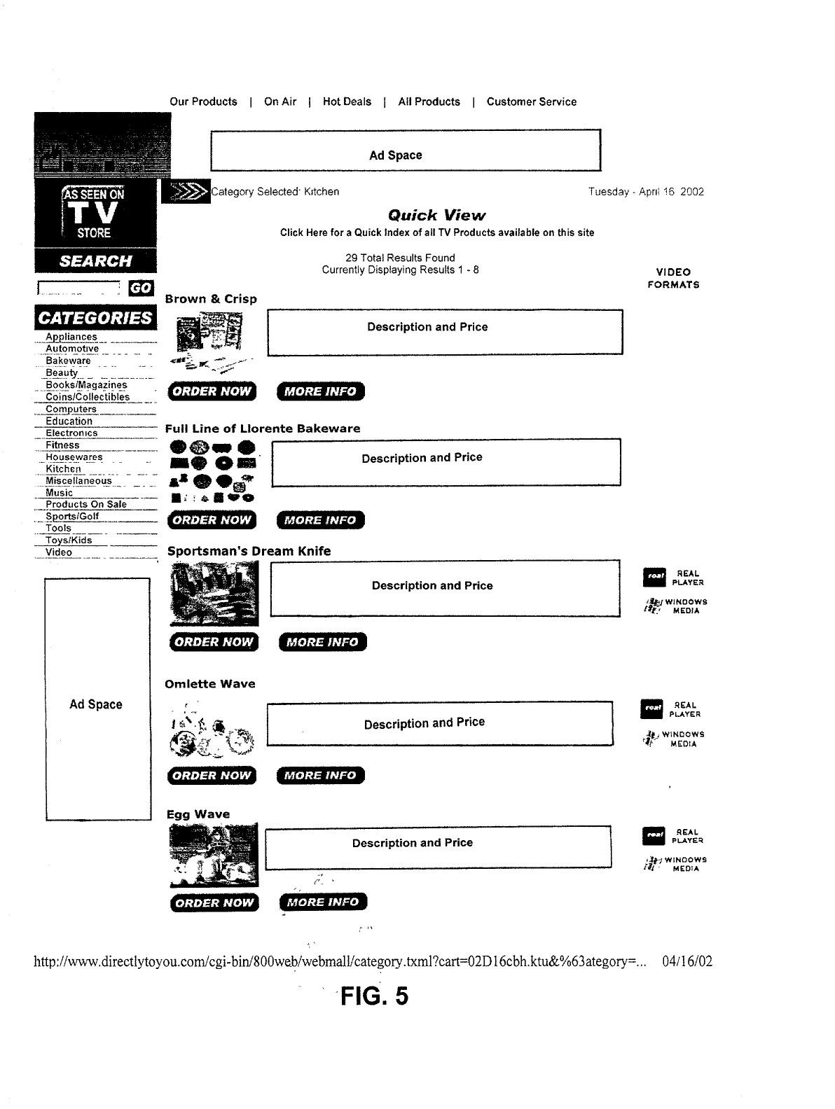

In contrast, the lateral company does not offer an omelet making product of its own. As a result, its subsequent web pages under its “Kitchen” hyperlink prominently displays both the Omelet Wave product and the Perfect Omelet product for sale as shown in FIG. 5. Thus, under certain circumstances, a customer of this lateral company may purchase either omelet making product, and if he or she does, the lateral company will receive a commission on the sale as previously discussed. Thus, where a product of the target company directly competes with a product of another participating company, the product of the target company will be displayed and not the competing product.

Where the target company does not offer a product that competes with respect to two lateral products that directly compete with each other, the target company is neutral with respect to these two lateral products, and thus both competing products may be equally offered to the target company's customers or the first such competing product may enjoy a priority depending on the arrangements made by the host organization. In this way, conflicts due to directly competing products are avoided only where the target company has a direct financial interest. In other instances, the customers of participating lateral organizations that do not have a directly competing product may be offered a lateral product from a participating lateral organization that was “first to enter the network” over a directly competing product from another participating organization. In yet other instances, the competing products may simply compete side by side to customers of a target organization that does not have a similarly competing product, and the target organization will enjoy a commission upon a sale of either competing product.

Where a customer orders one or more target products as well as one or more lateral products, the sale of the target product is effectively transacted by the target organization, and sale of the lateral company is effectively transacted by the lateral organization. Likewise, the target product, or certificate identifying the target service(s), including any upsell products or certificates identifying the upsell service(s), are consolidated and delivered from the fulfillment house of the target organization; whereas the lateral product, or certificate identifying the lateral service(s), including any upsell products or certificates identifying the upsell service(s), are consolidated and delivered from the fulfillment house of the lateral organization.

This approach can also be integrated with a method of upselling of additional products or services once a base product or service is sold in keeping with Applicant's co-pending application filed Apr. 19, 2002 entitled SYSTEM OF UPSELLING IN A COMPUTER NETWORK ENVIRONMENT, serial number not yet assigned. That application, including its description, is incorporated herein by reference.

While the present invention has been described with regards to particular embodiments, it is recognized that additional variations of the present invention may be devised without departing from the inventive concept.

What is claimed is:

1. A method of allowing interactive selling of products or services over a global computer network by a plurality of normally competing and participating organizations, comprising the steps of:
advertising for sale by a target organization of one or more of its target products or services and offering to transact a sale of said target product or service through a target website in a global computer network;
displaying one or more web pages which display lateral products or services for sale by participating lateral organizations; and
allowing those participating lateral organizations to thereby offer for sale their lateral products or services.

2. The method as set forth in claim 1, further comprising the step of completing a sale of one or more lateral products or services.

3. The method as set forth in claim 1, further comprising the step of offering for sale all such lateral products or services through said target website.

4. The method as set forth in claim 1, further comprising the step of offering for sale all such lateral products or services through a host website informationally connected to said target website.

5. The method as set forth in claim 1, further comprising sharing revenue from said sale of said one or more lateral product or service with said target organization.

6. The method as set forth in claim 2, wherein said revenue sharing comprises a payment to the organization selling the lateral products or services for the price of the lateral products or services with a commission therefrom to the benefit of the target organization.

7. The method as set forth in claim 2, further comprising the step of allowing for delivery of the lateral products or services through the organizations offering such lateral products or services and delivery of a target product or service, if purchased, through said target organization.

8. The method as set forth in claim 1, wherein the lateral organization is a direct competitor of the target organization.

9. The method as set forth in claim 2, further comprising the step of selectively removing from the display of lateral products or services one or more product or service of said lateral organization that directly compete with a product or service of said target organization.

10. The method as set forth in claim 1, further comprising the steps of completing a sale of a target product or service:
thereafter offering for sale one or more upsell products or services as a separate and distinct transaction from the sale of the target product or service;
completing said sale of said accepted upsell products or services;
consolidating the sale of said target product or service and the sale of said upsell products or services.

11. A method of increasing the number of products and services marketed and sold over a global computer network to an organization's customers, comprising the steps of:
displaying a target product or service for sale by a target organization;
offering to transact a sale of said target product or service through a target website in a global computer network;
displaying one or more subsequent web pages comprising displays of one or more lateral products or services offered for sale by one or more lateral organizations; and
allowing for sale of the one or more lateral products or services through the website of the target organization such that a customer can purchase through the website of the target organization such displayed lateral products or services and which thereby allows the target organization to increase the content of products or services offered through the target website not normally offered by the target organization.

12. The method as set forth in claim 11, wherein the displayed lateral products or services are not normally offered by the target organization.

13. The method as set forth in claim 11, wherein the other lateral organization is a direct competitor of the target organization.

14. The method as set forth in claim 11, further comprising revenue sharing to any organization whose products or services are sold over the website of the party offering the target product or service.

15. The method as set forth in claim 13, further comprising the step of selectively removing from said displays of one or more lateral products or services of said other organization that directly compete with a product or service of said target organization.

16. The method as set forth in claim 14, wherein said revenue sharing, comprises a payment to the organization selling the lateral products or services for the price of the lateral product or service with a commission therefrom to the benefit of the target organization.

17. The method as set forth in claim 14, further comprising the step of allowing for delivery of the lateral products or services through the lateral organization offering such lateral products or services and delivery of the target product or service through the organization offering such target product or service.

18. The method as set forth in claim 17, further comprising the steps of:
allowing for delivery of the lateral products or services through the lateral organization offering such lateral products or services and delivery of the target product or service through the organization offering such target product or service; and
causing payment by a customer of such products or services to the respective organization to who offered such products or services.

19. The method as set forth in claim 10, further comprising the steps of:
completing a sale of target product service
thereafter offering for sale one or more upsell products or services as a separate and distinct transaction from the sale of the target product or service;
completing said sale of said accepted upsell products or services;
consolidating the sale of said target product or service and the sale of said upsell products or services.

20. A method of revenue sharing of sales over a global computer network, comprising the steps of:
displaying a target product or service for sale by a target organization;
offering to transact a sale of said target product or service through a target website in a global computer network;
displaying one or more websites having displays of one or more lateral products or services normally offered for sale by other lateral organizations; and
allowing for sale of the one or more lateral products or services through the website of the target organization with revenue sharing to the lateral organization whose product or service is sold and the target organization.

21. The method as set forth in claim 20, further comprising the step of allocating revenue to the lateral organization for lateral products or services sold and allocating a commission to the target organization.

22. The method as set forth in claim 20, further comprising the step of allowing for delivery of the lateral products or services through the lateral organizations offering such lateral products or services and delivery of the target product or service through the target organization offering said target product or service.

23. The method as set forth in claim 22, further comprising the steps of:
allowing for delivery of the lateral products or services through the lateral organizations offering such lateral products or services and delivery of the target product or service through the target organization offering said product or service; and
causing payment by a customer of each product or service to the respective organizations who offered such products or services.

24. The method as set forth in claim 20, wherein the lateral organization is a direct competitor of the target organization.

25. The method as set forth in claim 24, further comprising the step of selectively removing from said displays of one or more lateral products or services of said lateral organization that directly compete with a product or service of said target organization.

26. The method as set forth in claim 20, further comprising the steps of completing a sale of a target product or service:
thereafter offering for sale one or more upsell products or services as a separate and distinct transaction from the sale of the target product or service.

27. The method of revenue sharing of sales over a global computer network, comprising the steps of:
advertising a target product or service for sale by a target company;
offering to transact a sale of said target product or service through a target website in a global computer network;
receiving an instruction from a customer to visit the target website;
displaying said target product or service on the target website;
displaying one or more subsequent web pages of a lateral organization which displays lateral products or services for sale by other participating lateral organizations;
receiving an instruction from the customer to purchase a product or service; and
determining whether said target company is entitled to a commission on said sale.

28. The method as set forth in claim 27, wherein one or more of said other participating companies are direct competitors of said target company.

29. The method as set forth in claim 27, further comprising the steps of:
maintaining customer information comprising a code to a corresponding target website;
maintaining product information comprising a supplier code, a price, and a commission amount for each product purchased by a customer; and
comparing said customer information and said product information for said purchased product to determine whether said target company is entitled to a commission on said sale.

30. The method as set forth in claim 27, further comprising the step of removing from said displays of lateral products one or more products of said other participating companies that directly compete with a product of said target company.

31. The method as set forth in claim 27, further comprising the step of:
completing said sale of said purchased products;
thereafter offering for sale one or more upsell products;
receiving an instruction from a customer accepting said one of said offers for sale of said one or more upsell products; and
shipping accepted upsell products with said purchased product.

32. The method of revenue sharing of sales over a global computer network comprising:
selling a base product or service to a customer and completing the sale thereof; and
thereafter offering and attempting to sell one or more upsell products or services to the customer and then completing any sale thereof while keeping the sale of the base product or service completely separate from any sale of an upsell product or service to thereby reduce compromise of a sale of the base product or service.

33. The method of revenue sharing of sales as set forth in claim 32, further comprising the step of consolidating the sale of the base product or service and any sale of the upsell products or services after completion of the sales thereof.

34. The method of revenue sharing of sales as set forth in claim 33, wherein the step of providing subsequent consolidation of sales of the products or services and notification to the customer comprises determining and advising the customer of the total price of said base product or service and any upsell products or services.

35. A method of revenue sharing of sales over a global computer network, comprising the steps of:
advertising a base product for sale by a target company;
offering to transact a sale of said base product through a target website in a global computer network;
receiving an instruction from a customer to visit the target website;
displaying said base product on the target website;
displaying one or more hyperlinks to subsequent web pages, said subsequent web pages comprising displays of lateral products for sale by other participating companies;
maintaining customer information comprising a code corresponding to the target website;
receiving an instruction from the customer to purchase a product;
maintaining product information comprising a supplier code, a price, and a commission amount for each product; and
comparing said customer information and said product information for said purchased product to determine whether said target company is entitled to a commission on said sale.

36. A method as set forth in claim 35, wherein one or more of said other participating companies are direct competitors of said target company.

37. A method as set forth in claim 35, further comprising the step of removing from said displays of lateral products one or more products of said other participating companies that directly compete with a product of said target company.

38. A method as set forth in claim 35, further comprising the steps of:
completing said sale of said purchased product;
thereafter offering for sale one or more upsell products;
receiving an instruction from a customer accepting said one of said offers for sale of said one or more upsell products;
completing said sale of said accepted upsell products; and
shipping accepted upsell products with said purchased product.
